(19) United States
(12) Patent Application Publication
(10) Pub. No.: US 2010/0155638 A1
(43) Pub. Date: Jun. 24, 2010

(54) ELECTROMAGNETIC VALVE, AS WELL AS A METHOD FOR PRODUCING AN ELECTROMAGNETIC VALVE

(75) Inventor: Janusz Zurke, Straelen (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: PIERBURG GMBH, Neuss (DE)

(21) Appl. No.: 12/595,935

(22) PCT Filed: Mar. 20, 2008
(86) PCT No.: PCT/EP08/02244

§ 371 Date: Feb. 2, 2010

(30) Foreign Application Priority Data
Apr. 14, 2007 (DE) 10 2007 017 674.2
Jun. 22, 2007 (DE) 10 2007 028 910.5

(51) Int. Cl. F16K 31/02; B21K 1/20

(52) U.S. Cl. 251/129.15; 29/890.124

(57) ABSTRACT

An electromagnetic valve includes a housing, a coil wound on a coil support, a back iron, a yoke, a mobile armature, and a core. The core is disposed together with the armature radially inside the coil support. The armature is configured to connect, at least indirectly, with a closing member that controls a movement of a valve seat moveable between inlet channel and an outlet channel. A bearing bushing formed of injection molded plastic material is disposed radially inside the coil support and axially against the yoke, wherein the armature and the core are disposed radially inside the bearing bushing.

### CROSS REFERENCE TO PRIOR APPLICATIONS

This application is a U.S National Phase application under 35 U.S.C. §371 of International Application No. PCT/EP2008/002244, filed on Mar. 20, 2008 and which claims benefit to German Patent Application No. 10 2007 017 674.2, filed on Apr. 14, 2007 and to German Patent Application No. 10 2007 028 910.5, filed on Jun. 22, 2007. The International Application was published in German on Oct. 23, 2008 as WO 2008/125179 A1 under PCT Article 21(2).

### FIELD

The present invention refers to an electromagnetic valve with a housing and an electromagnetic circuit formed by a coil wound on a coil support, an armature, a core, a back iron and a yoke, wherein the mobile armature is arranged and supported radially within the coil support and is at least indirectly connected with a closing member that controls a valve seat between an inlet channel and an outlet channel, the armature and the core being arranged radially within a bearing bushing that is arranged radially within the coil support, as well as to a method for manufacturing such an electromagnetic valve.

### BACKGROUND

Numerous different fields of application in internal combustion engines are known for electromagnetic valves. For instance, electromagnetic valves are used both in pneumatic and in hydraulic circuits in vehicles, such as in braking systems, transmission systems or injection systems. Their application ranges from controlling pressure in pneumatic actuators to bypass control as diverter valves in turbo chargers. Depending on the field of application, these electromagnetic valves are designed either as open/close valves or as regulating valves. Especially when used as a regulating or control valve, a coaxial offset of the armature in the magnetic circuit should be prevented since this generates radial forces that have negative effects on the desired axial forces.

DE 42 05 565 C2 describes an electropneumatic pressure transducer comprising a core crewed into a threaded bushing, which threaded bushing may be formed integrally with the back iron. The armature is supported in a DU bushing which in turn is arranged in a steel bushing that is pressed within the coil support. Faulty alignment between the components guiding the armature or fixing the core results in a non-negligible coaxial error of the armature with respect to the core. In addition, deformations of the coil support caused by winding the coil, assembling the electromagnetic circuit or injection molding the housing, result in a further aggravation of this coaxial error. An overall deformation of the housing may well be counteracted by the stabilizing components of the steel bushing or the DU bushing, respectively, however, a coaxial offset between the core and the armature can not be excluded thereby.

DE 101 46 497 A1 describes a further embodiment of an electromagnetic control valve wherein a hollow cylindrical armature is supported immediately in a coil support of corresponding design which thus serves as a sliding bearing for the armature and is made from injection molded plastic material. With such an embodiment, however, it is necessary that the coil support is wound on after injection molding and that also the rest of the assembly of the valve is performed after the injection molding process which again results in a clear warping of the coil support and thus causes a coaxial offset between the armature and the core that entails undesired radial forces in the gap between the armature and the core.

To avoid this coaxial error, DE 40 39 324 A1 describes pressing a bearing bushing into the coil support. Arranged radially inside the bearing bushing at the opposite axial ends thereof are a stationary valve part and a pole member in which a respective bearing ring is provided for supporting the armature. Since these components must be inserted after the bearing bushing has been pressed in and the further assembly is also carried out in subsequent manufacturing steps, a coaxial offset caused thereby, in particular of the bearing rings with respect to each other, can again not be excluded.

### SUMMARY

An aspect of the present invention is to provide an electromagnetic valve, as well as a method for manufacturing such an electromagnetic valve with which the coaxial errors occurring are minimized reliably without increasing the number of component parts. It is intended to thereby provide an improved and less wear-prone, as well as more economic electromagnetic valve.

In an embodiment, the present invention provides an electromagnetic valve including a housing, a coil wound on a coil support, a back iron, a yoke, a mobile armature, and a core. The core is disposed together with the armature radially inside the coil support. The armature is configured to connect, at least indirectly, with a closing member that controls a movement of a valve seat moveable between inlet channel and an outlet channel. A bearing bushing formed of injection molded plastic material is disposed radially inside the coil support and axially against the yoke, wherein the armature and the core are disposed radially inside the bearing bushing. A bushing manufactured in this way can be provided after the injection molding of the housing even when undercuts exist between the yoke and the back iron. In this instance, no increased stability of the bushing is required since no further stresses are subsequently generated that could cause warping. A coaxial offset between the core and the armature can thus be reliably avoided in an economic manner without requiring additional components for stabilization.

In an embodiment, the present invention also provides for a method for manufacturing an electromagnetic valve. The method includes winding a coil on a coil support, assembling the coil support, a yoke and a back iron, forming a bearing bushing by injecting a plastic material into the coil support after the assembly step, and disposing an armature and a core radially inside the bearing bushing after the forming step. A coaxial offset between the core and the armature can be avoided in a reliable manner. By performing this as the last manufacturing step, a posterior warping of the bearing bushing due to thermal or mechanical forces can thus be avoided.

### BRIEF DESCRIPTION OF THE DRAWINGS

The present invention is described in greater detail below on the basis of embodiments and of the drawings in which:

FIG. 1 illustrates a sectional side elevational view of a prior art electromagnetic circuit of an electropneumatic pressure transducer.

FIG. 2 illustrates a sectional side elevational view of an electromagnetic circuit of an electromagnetic valve according to the present invention using the example of an electropneumatic pressure transducer.

FIG. 3 illustrates, as an alternative to FIG. 2, a sectional side elevational view of an electromagnetic circuit of an electromagnetic valve according to the present invention using the example of an electropneumatic pressure transducer.

FIG. 4 illustrates, as an alternative to FIGS. 2 and 3, a sectional side elevational view of another electromagnetic circuit of an electromagnetic valve according to the present invention using the example of an electropneumatic pressure transducer.

### DETAILED DESCRIPTION

The bearing bushing is, for example, defined axially at a first end by a radial inner part of the back iron and, at the opposite end, by a radial inner part of the yoke. Injecting the plastic material is effected such that an injection tool is inserted into the coil support, the back iron and the yoke serving as locating points for the same. Accordingly, when proceeding in this manner, the sliding bearing bushing automatically conforms to the alignment existing between the yoke and the back iron, whereby previously formed tolerances of shape and position are eliminated. Moreover, expensive lathed parts, such as the steel bushing or the DU bushing, that would otherwise serve as reinforcements, can be omitted.

In a development of the above electromagnetic valve embodiment or a development of the method for manufacturing such an electromagnetic valve, the core is pressed into the injected slide bearing bushing, whereby a very small coaxial error between the core and the armature is guaranteed so that radial forces acting between the magnetic parts are again reliably avoided.

In an embodiment, the core is fastened by injecting the sliding bearing bushing. This also clearly defines the position of the armature relative to the core, while, in addition, another manufacturing step is omitted.

In an embodiment, the yoke and the back iron are deep-drawn parts. Such parts are very economic to manufacture, the more so since the embodiment according to the present invention does not call for strict requirements to be met regarding the tolerances of the yoke or the back iron, respectively, because the guide in the form of the sliding bearing bushing automatically adjusts to these tolerances.

The yoke and the back iron, for example, have radial inward cylindrical sections that extend from the opposite axial ends of the coil support at least partly into the cylindrical cavity of the coil support. Accordingly, these cylindrical sections serve, for example, as alignment points for injecting the sliding bearing bushing. The cylindrical sections thus serve as stop and rest surfaces for the injection core and as defined axial ends of the sliding bearing bushing. Further, the surface of contact with the armature and the core is increased, respectively.

If a corresponding plastic material is selected, the bearing bushing may serve as a sliding bearing of the armature. Thereby, additional manufacturing steps and components can be omitted so that the electromagnetic valve can be manufactured economically.

As an alternative, an additional sliding bearing bushing can be arranged radially within the bearing bushing, whereby the sliding characteristics can be improved further, if necessary, without having to drop the coaxial compensation provided by the bearing bushing. To this end, the sliding bearing bushing is pressed or pushed into the bearing bushing.

In an embodiment, an improvement of the sliding characteristics is achieved by coating the armature with a sliding film or a sliding lacquer. This sliding lacquer can be applied onto the armature in a further manufacturing step.

Such a method for manufacturing the electromagnetic valve can be realized with simple means and, as compared with known manufacturing methods, very economically. The electromagnetic valve comprises fewer components which moreover are simple to manufacture, while at the same time largely minimizing the occurring transverse and radial forces, whereby less wear and a longer service life are achieved.

The electromagnetic circuit 1 of an electromagnetic valve, illustrated in FIG. 1, which takes the shape of an electropneumatic transducer in the present instance, is comprised of a coil support 2 on which a coil 3 is wound, as well as a core 4 fixedly arranged inside the coil support 2 which is in magnetic communication with a mobile armature 5 also arranged inside the coil support 2. The electromagnetic circuit 1 is closed by a back iron 6 at a first axial end of the coil support 2, as well as by a yoke 7.

The yoke 7 surrounds the coil support 2 with the coil 3 wound thereon. The armature 5 is slidably arranged in a sliding bearing bushing 8 that is realized as a DU bushing. This DU bushing 8 is situated radially inside of and coaxial with a steel bushing 9 whose outer circumference contacts the coil support 2 and is pressed into the coil support for an increase in rigidity before the DU bushing 8 is mounted.

The core 4 is of a bipartite structure and is formed by an inner core member 10 and an outer core member 11 that radially surrounds the inner core member 10 and is coaxial with the same, the outer core member being surrounded by a threaded sleeve 12 which in turn is coaxial with the core 4 and whose outer surface contacts the coil support 2. The threaded sleeve 12 has a female thread mating with a male thread of the outer core member 11. Like-wise, the outer core member 11 has a female thread mating with a male thread of the inner core member 10, the inner core member extending into a corresponding circular recess 13 in the armature 5. The outer core member 11 also has a circular recess 14 at the end directed towards the armature 5, the diameter of this recess being slightly larger than the outer diameter of the armature 5 so that the same can dip somewhat into the recess 14 when the electromagnet is actuated. These recesses serve to bundle electromagnetic field lines.

The threaded sleeve 12 is fixedly connected with the back iron 6 by being pressed in, for instance. This back iron 6 in turn has a connection with the yoke 7, which itself is in press fit engagement with the steel bushing 9, Accordingly, the electromagnetic field lines, which are created when the coil 3 is energized, run through the armature 5 and the core 4 along the back iron 6 and the yoke 7.

In the non-energized state, a gap 15 exists between the armature 5 and the core 4, in which gap a magnetic field is created when the coil 3 is energized, thereby causing an axial movement of the armature 5. Accordingly, the axial end of the armature 5 opposite the core 4 is lifted from a valve seat, not illustrated herein, when the coil 3 is energized. The further functions of the electropneumatic transducer are irrelevant to the present invention. Reference is made to the corresponding prior art. Relevant is the possibility to move a closing member coupled with the armature 5 by displacing the latter, whereby a fluid communication between an inlet channel and an outlet channel, not illustrated herein, can be established.

The bipartite structure of the core 4 serves to adjust the air gap between the armature 5 and the core 4 and thus to adjust the magnetic characteristic, whereby the action of force on the armature 5 can be adjusted. Here, turning the outer core member 11 causes a relatively large change in the force generated, whereas turning the second core member 10 in serves fine adjustment.

Upon a slight offset of the core 4 with respect to the armature 5, i.e. upon the occurrence of a coaxial error in the position of the armature 5 relative to the core 4, increased radial forces occur, whereby the axial forces are diminished and a greater wear materializes due to the not exactly straight movement of the armature 5 in the DU bushing 8. By pressing the DU bushing 8, whose shape is invariable, into the steel bushing 9, possible earlier coaxial errors resulting from the assembly of the coil support 2 and the steel bushing 9, the yoke 7 and the back iron 6, can not be compensated for.

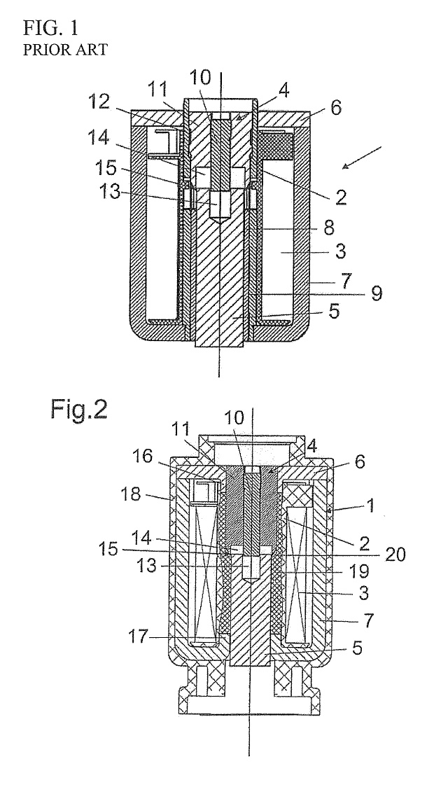

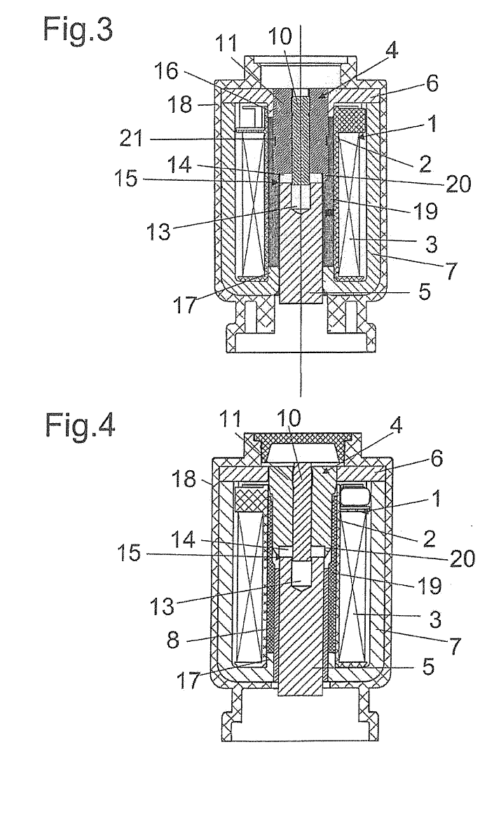

Accordingly, it is suggested for the electromagnetic valves of FIGS. 2 and 3 to first wind the coil support 2 and to then connect the yoke 7 and the back iron 6 with the coil support. To this end, the yoke 7 and the back iron 6 are designed as deep-drawn parts bent inward towards the coil support 2 to provide the necessary stability of the electromagnetic circuit 1 prior to the installation of the core 4 and the armature 5. This means that, at the axial end of the coil support 2, at which the core 4 is mounted, the back iron 6 is bent to a cylindrical shape at its inner diameter, wherein the cylindrical section 16 fixedly contacts the inner wall of the axially extending cylindrical cavity of the coil support 2 and extends towards the armature 5.

Likewise, at the opposite end of the coil support 2, the yoke 7 has a cylindrical section 17 that also extends into the axially extending cylindrical cavity of the coil support 2 and contacts the inner wall of the coil support 2. The cylindrical section 17 extends towards the core 4.

After the above described assembly of the components of the electromagnetic circuit 1, these components of electromagnetic circuit 1 can also be overmolded, thereby forming a housing 18 that surrounds the electromagnetic circuit at least radially and which may also be formed with fittings for inlets or outlets.

These steps having been performed, the coil support 2 is subsequently no longer stressed mechanically or thermally. Now, it is possible to make a bearing bushing 19 by first inserting a correspondingly shaped injection core into the region between the two cylindrical sections 16 and 17 of the yoke 7 and the back iron 6, the outer surface of this core contacting the cylindrical sections 16, 17 of the yoke 7 and the back iron 6, and by subsequently injecting plastic material into the cavity between the injection core and the coil support 2 so that the bearing bushing 19 formed contacts the coil support 2 by its outer periphery and has its axial ends abut against the back iron 6 and the yoke 7.

Due to this proceeding, the bearing bushing 19 conforms to the alignment between the yoke 7 and the back iron 6 and also automatically compensates for irregularities in the axially extending cylindrical cavity of the coil support 2. In addition, this bearing bushing 19 also serves as a sliding bearing for the armature, wherein additional stabilizing bushings are no longer required.

Like the injection core used in the manufacturing process, the radially inner surface of the bearing bushing 19 has a step 20 situated approximately on the level on which the end of the core 4 facing the armature 5 is located. After the bearing bushing 19 has been injected, the armature 5 can be inserted.

In an embodiment according to FIG. 2, the core 4 is pressed into the bearing bushing 19. Another advantage is obtained if the core 4 is immediately co-injected in one manufacturing step as the bearing bushing 19 is injection molded, as illustrated in FIG. 3. In such an embodiment, it is advantageous for the core 4 to have a circumferential groove 21 into which the plastic material of the bearing bushing 19 may settle upon injection so that the position of the core 4 is additionally fixed axially.

Should the sliding characteristics of the plastic material be insufficient for certain applications, an additional sliding bearing bushing 8 may be pushed or pressed into the bearing bushing 19, as illustrated in FIG. 4. In such an embodiment, the coaxial orientation of the core 4 and the armature 5 is maintained. Compared with the steel bushing inserted, the advantage remains that a more economical manufacturing is achieved and that it is possible to insert the bearing bushing 19 after the valve has been assembled and if undercuts exist, so that a subsequent warping can be excluded.

In the embodiment in FIG. 4, it is also evident that the back iron 6 does not necessarily have to serve as an axial stop for the bearing bushing 19. When a corresponding injection core is used, the bearing bushing 19 may also be shorter, whereas the core 4 has to be fastened in the bearing bushing 19. The further structure of the electromagnetic valve corresponds to that shown in FIG. 2 so that the same numerals are used.

In comparison with the example illustrated in FIG. 1, it is clear that both the number of manufacturing steps and that of the components used are drastically reduced while at the same time a coaxial error between the core 4 and the armature 5 is reliably avoided. This results in less wear at the valve and the prevention of undesirable radial forces. Tolerances of shape and position of the back iron 6 and the yoke 7, respectively, and thus of the core 4 with respect to the armature 5, which tolerances are caused during assembly, are compensated for in a reliable manner.

Such an electromagnetic valve can perform many different functions, wherein such a structure is feasible in particular where a control operation is required, i.e. where such a valve is used as a control valve in which transverse forces have to be prevented completely, if possible. Accordingly, it is conceivable to choose different embodiments of the yoke or the back iron or the coil support, however, as provided by the present invention, the plastic material should be injected into the valve when it is fully assembled except for the armature and the core.

The present invention is not limited to embodiments described herein; reference should be had to the appended claims.

### DESCRIPTION

An electromagnetic valve, as well as a method for manufacturing an electromagnetic valve

The invention refers to an electromagnetic valve with a housing and an electromagnetic circuit formed by a coil wound on a coil support, an armature, a core, a back iron and a yoke, wherein the mobile armature is arranged and supported radially within the coil support and is at least indirectly connected with a closing member that controls a valve seat between an inlet channel and an outlet channel, the armature and the core being arranged radially within a bearing bushing that is arranged radially within the coil support, as well as to a method for manufacturing such an electromagnetic valve.

Numerous different fields of application in internal combustion engines are known for electromagnetic valves. For instance, electromagnetic valves are used both in pneumatic and in hydraulic circuits in vehicles, such as in braking systems, transmission systems or injection systems. Their application ranges from controlling pressure in pneumatic actuators to bypass control as diverter valves in turbo chargers. Depending on the field of application, these electromagnetic valves are designed either as open/close valves or as regulating valves. Especially when used as a regulating or control valve, it is important to prevent a coaxial offset of the armature in the magnetic circuit since this generates radial forces that have negative effects on the desired axial forces.

Such an electromagnetic valve of the prior art is disclosed in DE 42 05 565 C2. The electropneumatic pressure transducer described therein comprises a core crewed into a threaded bushing, which threaded bushing may be formed integrally with the back iron. The armature is supported in a DU bushing which in turn is arranged in a steel bushing that is pressed within the coil support. Faulty alignment between the components guiding the armature or fixing the core results in a non-negligible coaxial error of the armature with respect to the core. In addition, deformations of the coil support caused by winding the coil, assembling the electromagnetic circuit or injection moulding the housing, result in a further aggravation of this coaxial error. An overall deformation of the housing may well be counteracted by the stabilizing components of the steel bushing or the DU bushing, respectively, however, a coaxial offset between the core and the armature can not be excluded thereby.

Further, an embodiment of an electromagnetic control valve as of DE 101 46 497 A1 is known, wherein a hollow cylindrical armature is supported immediately in a coil support of corresponding design which thus serves as a sliding bearing for the armature and is made from injection moulded plastic material. With such an embodiment, however, it is necessary that the coil support is wound on after injection moulding and that also the rest of the assembly of the valve is performed after the injection moulding process which again results in a clear warping of the coil support and thus causes a coaxial offset between the armature and the core that entails undesired radial forces in the gap between the armature and the core.

To avoid this coaxial error, it is suggested in DE 40 39 324 A1, to press a bearing bushing into the coil support. Arranged radially inside the bearing bushing at the opposite axial ends thereof are a stationary valve part and a pole member in which a respective bearing ring is provided for supporting the armature. Since these components must be inserted after the bearing bushing has been pressed in and the further assembly is also carried out in subsequent manufacturing steps, a coaxial offset, in particular of the bearing rings with respect to each other, caused thereby can again not be excluded.

Therefore, it is an object of the invention to provide an electromagnetic valve, as well as a method for manufacturing such an electromagnetic valve with which the coaxial errors occurring are minimized reliably without increasing the number of component parts. It is intended to thereby provide an improved and less wear-prone, as well as more economic electromagnetic valve.

This object is achieved with an electromagnetic valve in which the bearing bushing is formed by plastic material injected into the wound coil support and axially against the yoke. A bushing manufactured in this way can be provided after the injection moulding of the housing even when undercuts exist between the yoke and the back iron. In this instance, no increased stability of the bushing is required anymore since no further stresses are generated subsequently that could cause warping. Thus a coaxial offset between the core and the armature can be reliably avoided in an economic manner without requiring additional components for stabilization.

Moreover, this object is achieved with a method for manufacturing an electromagnetic valve, wherein, after the coil has been wound on the coil support and the coil support, the yoke and the back iron have been assembled, the bearing bushing is made by injecting plastic material into the coil support, and wherein the armature and the core are subsequently arranged radially inside the bearing bushing. Thus, a coaxial offset between the core and the armature can be avoided in a reliable manner. By performing this as the last manufacturing step, a posterior warping of the bearing bushing due to thermal or mechanical forces is avoided.

Preferably, the bearing bushing is defined axially at a first end by a radial inner part of the back iron and, at the opposite end, by a radial inner part of the yoke. Injecting the plastic material is effected such that an injection tool is inserted into the coil support, the back iron and the yoke serving as locating points for the same. Accordingly, when proceeding in this manner, the sliding bearing bushing automatically conforms to the alignment existing between the yoke and the back iron, whereby previously formed tolerances of shape and position are eliminated. Moreover, expensive lathed parts, such as the steel bushing or the DU bushing, that would otherwise serve as reinforcements, can be omitted.

In a development of the above electromagnetic valve embodiment or a development of the method for manufacturing such an electromagnetic valve, the core is pressed into the injected slide bearing bushing, whereby a very small coaxial error between the core and the armature is guaranteed so that again radial forces acting between the magnetic parts are reliably avoided.

In an alternative embodiment thereof or an alternative manufacturing method, the core is fastened by injecting the sliding bearing bushing. This also clearly defines the position of the armature relative to the core, while, in addition, another manufacturing step is omitted.

In a developed embodiment, the yoke and the back iron are deep-drawn parts. Such parts are very economic to manufacture, the more so since the embodiment according to the invention does not call for strict requirements to be met regarding the tolerances of the yoke or the back iron, respectively, because the guide in the form of the sliding bearing bushing automatically adjusts to these tolerances.

Preferably, the yoke and the back iron have radial inward cylindrical sections that extend from the opposite axial ends of the coil support at least partly into the cylindrical cavity of the coil support. Accordingly, it is preferred that these cylindrical sections serve as alignment points for injecting the sliding bearing bushing. The cylindrical sections thus serve as stop and rest surfaces for the injection core and as defined axial ends of the sliding bearing bushing. Further, the surface of contact with the armature and the core is increased, respectively.

If a corresponding plastic material is selected, the bearing bushing may serve as a sliding bearing of the armature. Thereby, additional manufacturing steps and components can be omitted so that the electromagnetic valve can be manufactured economically.

As an alternative, an additional sliding bearing bushing is arranged radially within the bearing bushing, whereby the sliding characteristics can be improved further, if necessary, without having to drop the coaxial compensation provided by the bearing bushing. To this end, the sliding bearing bushing is pressed or pushed into the bearing bushing.

In another alternative embodiment, an improvement of the sliding characteristics is achieved by coating the armature with a sliding film or a sliding lacquer. This sliding lacquer is applied onto the armature in a further manufacturing step.

Such a method for manufacturing the electromagnetic valve can be realized with simple means and, as compared with known manufacturing methods, very economically. The electromagnetic valve comprises fewer components which moreover are simple to manufacture, while at the same time largely minimizing the occurring transverse and radial forces, whereby less wear and a longer service life are achieved.

An embodiment and a valve according to the prior art are illustrated in the drawings and will be detailed hereunder.

FIG. 1 illustrates a sectional side elevational view of a prior art electromagnetic circuit of an electropneumatic pressure transducer.

FIG. 2 illustrates a sectional side elevational view of an electromagnetic circuit of an electromagnetic valve according to the invention using the example of an electropneumatic pressure transducer.

FIG. 3 illustrates, as an alternative to FIG. 2, a sectional side elevational view of an electromagnetic circuit of an electromagnetic valve according to the invention using the example of an electropneumatic pressure transducer.

FIG. 4 illustrates, as an alternative to FIGS. 2 and 3, a sectional side elevational view of another electromagnetic circuit of an electromagnetic valve according to the invention using the example of an electropneumatic pressure transducer.

The electromagnetic circuit 1 of an electromagnetic valve, illustrated in FIG. 1, which takes the shape of an electropneumatic transducer in the present instance, is comprised of a coil support 2 on which a coil 3 is wound, as well as a core 4 fixedly arranged inside the coil support 2 which is in magnetic communication with a mobile armature 5 also arranged inside the coil support 2. The electromagnetic circuit 1 is closed by a back iron 6 at a first axial end of the coil support 2, as well as by a yoke 7.

The yoke 7 surrounds the coil support 2 with the coil 3 wound thereon. The armature 5 is slidably arranged in a sliding bearing bushing 8 that is realized as a DU bushing. This DU bushing 8 is situated radially inside of and coaxial with a steel bushing 9 whose outer circumference contacts the coil support 2 and is pressed into the coil support for an increase in rigidity before the DU bushing 8 is mounted.

The core 4 is of a bipartite structure and is formed by an inner core member 10 and an outer core member 11 that radially surrounds the inner core member 10 and is coaxial with the same, the outer core member being surrounded by a threaded sleeve 12 which in turn is coaxial with the core 4 and whose outer surface contacts the coil support 2. The threaded sleeve 12 has a female thread mating with a male thread of the outer core member 11. Like-wise, the outer core member 11 has a female thread mating with a male thread of the inner core member 10, the inner core member extending into a corresponding circular recess 13 in the armature 5. The outer core member 11 also has a circular recess 14 at the end directed towards the armature 5, the diameter of this recess being slightly larger than the outer diameter of the armature 5 so that the same can dip somewhat into the recess 14 when the electromagnet is actuated. These recesses serve to bundle electromagnetic field lines.

The threaded sleeve 12 is fixedly connected with the back iron 6 by being pressed in, for instance. This back iron 6 in turn has a connection with the yoke 7, which itself is in press fit engagement with the steel bushing 9, Accordingly, the electromagnetic field lines, which are created when the coil 3 is energized, run through the armature 5 and the core 4 along the back iron 6 and the yoke 7.

In the non-energized state, a gap 15 exists between the armature 5 and the core 4, in which gap a magnetic field is created when the coil 3 is energized, thereby causing an axial movement of the armature 5. Accordingly, the axial end of the armature 5 opposite the core 4 is lifted from a valve seat, not illustrated herein, when the coil 3 is energized. The further functions of the electropneumatic transducer are irrelevant to the present invention. Reference is made to the corresponding prior art. What is important is the possibility to move a closing member coupled with the armature 5 by displacing the latter, whereby a fluid communication between an inlet channel and an outlet channel, not illustrated herein, can be established.

The bipartite structure of the core 4 serves to adjust the air gap between the armature 5 and the core 4 and thus to adjust the magnetic characteristic, whereby the action of force on the armature 5 can be adjusted. Here, turning the outer core member 11 causes a relatively great change in the force generated, whereas turning the second core member 10 in serves fine adjustment.

However, it becomes clear that upon a slight offset of the core 4 with respect to the armature 5, i.e. upon the occurrence of a coaxial error in the position of the armature 5 relative to the core 4, increased radial forces occur, whereby the axial forces are diminished and a greater wear materializes due to the not exactly straight movement of the armature 5 in the DU bushing 8. It is also obvious that by pressing the DU bushing 8, whose shape is invariable, into the steel bushing 9, possible earlier coaxial errors resulting from the assembly of the coil support 2 and the steel bushing 9, the yoke 7 and the back iron 6, can not be compensated for.

Accordingly, it is suggested for the electromagnetic valves of FIGS. 2 and 3 to first wind the coil support 2 and to then connect the yoke 7 and the back iron 6 with the coil support. To this end, the yoke 7 and the back iron 6 are designed as deep-drawn parts bent inward towards the coil support 2 to provide the necessary stability of the electromagnetic circuit 1 prior to the installation of the core 4 and the armature 5. This means that, at the axial end of the coil support 2, at which the ore 4 is mounted, the back iron 6 is bent to a cylindrical shape at its inner diameter, wherein the cylindrical section 16 fixedly contacts the inner wall of the axially extending cylindrical cavity of the coil support 2 and extends towards the armature 5.

Likewise, at the opposite end of the coil support 2, the yoke 7 has a cylindrical section 17 that also extends into the axially extending cylindrical cavity of the coil support 2 and contacts the inner wall of the coil support 2. The cylindrical section 17 extends towards the core 4.

After the above described assembly of the components of the electromagnetic circuit 1, these components of electromagnetic circuit 1 can also be overmoulded, thereby forming a housing 18 that surrounds the electromagnetic circuit at least radially and which may also be formed with fittings for inlets or outlets.

These steps having been performed, the coil support 2 is subsequently no longer stressed mechanically or thermally. Now, it is possible to make a bearing bushing 19 by first inserting a correspondingly shaped injection core into the region between the two cylindrical sections 16 and 17 of the yoke 7 and the back iron 6, the outer surface of this core contacting the cylindrical sections 16, 17 of the yoke 7 and the back iron 6, and by subsequently injecting plastic material into the cavity between the injection core and the coil support 2 so that the bearing bushing 19 formed contacts the coil support 2 by its outer periphery and has its axial ends abut against the back iron 6 and the yoke 7.

Due to this proceeding, the bearing bushing 19 conforms to the alignment between the yoke 7 and the back iron 6 and also automatically compensates for irregularities in the axially extending cylindrical cavity of the coil support 2. In addition, this bearing bushing 19 also serves as a sliding bearing for the armature, wherein additional stabilizing bushings are no longer required.

Like the injection core used in the manufacturing process, the radially inner surface of the bearing bushing 19 has a step 20 situated approximately on the level on which the end of the core 4 facing the armature 5 is located. After the bearing bushing 19 has been injected, the armature 5 can be inserted.

In an embodiment according to FIG. 2, the core 4 is pressed into the bearing bushing 19. Another advantage is obtained if the core 4 is immediately co-injected in one manufacturing step as the bearing bushing 19 is injection moulded, as illustrated in FIG. 3. In such an embodiment, I is advantageous for the core 4 to have a circumferential groove 21 into which the plastic material of the bearing bushing 19 may settle upon injection so that the position of the core 4 is additionally fixed axially.

Should the sliding characteristics of the plastic material be insufficient for certain applications, an additional sliding bearing bushing 8 may be pushed or pressed into the bearing bushing 19, as illustrated in FIG. 4. In such an embodiment, the coaxial orientation of the core 4 and the armature 5 is maintained. Compared with the steel bushing inserted, the advantage remains that a more economical manufacturing is achieved and that it is possible to insert the bearing bushing 19 after the valve has been assembled and if undercuts exist, so that a subsequent warping can be excluded.

In the embodiment in FIG. 4, it is also evident that the back iron 6 does not necessarily have to serve as an axial stop for the bearing bushing 19. When a corresponding injection core is used, the bearing bushing 19 may also be shorter, whereas the core 4 has to be fastened in the bearing bushing 19. The further structure of the electromagnetic valve corresponds to that shown in FIG. 2 so that the same numerals are used.

In comparison with the example illustrated in FIG. 1, it is clear that both the number of manufacturing steps and that of the components used are drastically reduced while at the same time a coaxial error between the core 4 and the armature 5 is reliably avoided. This results in less wear at the valve and the prevention of undesirable radial forces. Tolerances of shape and position of the back iron 6 and the yoke 7, respectively, and thus of the core 4 with respect to the armature 5, which tolerances are caused during assembly, are compensated for in a reliable manner.

It should be obvious that such an electromagnetic valve can perform many different functions, wherein such a structure is feasible in particular where a control operation is required, i.e. where such a valve is used as a control valve in which transverse forces have to be prevented completely, if possible. Accordingly, it is conceivable to choose different embodiments of the yoke or the back iron or the coil support, however, as provided by the invention, the plastic material should be injected into the valve when it is fully assembled except for the armature and the core.

1-15. (canceled)

16. An electromagnetic valve comprising:
a housing;
a coil wound on a coil support;
a back iron;
a yoke;
a mobile armature;
a core, wherein the core is disposed together with the armature radially inside the coil support, the armature configured to connect, at least indirectly, with a closing member that controls a movement of a valve seat moveable between inlet channel and an outlet channel; and
a bearing bushing formed of injection molded plastic material disposed radially inside the coil support and axially against the yoke, wherein the armature and the core are disposed radially inside the bearing bushing.

17. The electromagnetic valve as recited in claim 16, wherein a first end of the bearing bushing is defined axially by a radially inner part of the back iron and an opposite second end of the bearing bushing is defined axially by a radially inner part of the yoke.

18. The electromagnetic valve as recited in claim 16, wherein the core is pressed into the bearing bushing.

19. The electromagnetic valve as recited in claim 16, wherein the core is fixed when forming the bearing bushing.

20. The electromagnetic valve as recited in claim 16, wherein the yoke and the back iron are deep-drawn parts.

21. The electromagnetic valve as recited in claim 16, wherein the yoke and the back iron both include radially inner cylindrical sections extending from the opposite axial ends of the coil support at least partly into the cylindrical cavity of the coil support.

22. The electromagnetic valve as recited in claim 16, wherein the bearing bushing serves as a sliding bearing of the armature.

23. The electromagnetic valve as recited in claim 16, further comprising a sliding bearing bushing disposed radially inside the bearing bushing.

24. The electromagnetic valve as recited in claim 16, wherein the armature is coated with at least one of a sliding film and a sliding lacquer.

25. A method for manufacturing an electromagnetic valve including a housing, the method comprising:
winding a coil on a coil support;
assembling the coil support, a yoke and a back iron;
forming a bearing bushing by injecting a plastic material into the coil support after the assembly step; and
disposing an armature and a core radially inside the bearing bushing after the forming step.

26. The method for manufacturing an electromagnetic valve as recited in claim 25, wherein the yoke and the back iron each include cylindrical sections which serve as alignment points when injecting the plastic material to form the bearing bushing.

27. The method for manufacturing an electromagnetic valve as recited in claim 25, further comprising pressing the core into the bearing bushing.

28. The method for manufacturing an electromagnetic valve as recited in claim 25, further comprising fixing the core by injecting the plastic material to form the bearing bushing.

29. The method for manufacturing an electromagnetic valve as recited in claim 25, further comprising pressing a sliding bearing bushing into the bearing bushing.

30. The method for manufacturing an electromagnetic valve as recited in claim 25, further comprising pushing a sliding bearing bushing into the bearing bushing.

31. The method for manufacturing an electromagnetic valve as recited in claim 25, further comprising covering the armature with at least one of a sliding film and a sliding lacquer.
